(19) United States
(12) Patent Application Publication
(10) Pub. No.: US 2008/0205778 A1
(43) Pub. Date: Aug. 28, 2008

(54) Image predicting apparatus and method, and image coding apparatus and method

(75) Inventors: Masayuki Tokumitsu, Kyoto (JP); Takahiro Yamasaki, Osaka (JP); Satoshi Nakagawa, Osaka (JP)

Correspondence Address: RABIN & Berdo, PC, 1101 14TH STREET, NW, SUITE 500, WASHINGTON, DC, 20005, US

(73) Assignee: OKI ELECTRIC INDUSTRIY CO., LTD., Tokyo (JP)

(21) Appl. No.: 12/068,106

(22) Filed: Feb. 1, 2008

(30) Foreign Application Priority Data
Feb. 28, 2007 (JP) JP-2007-049570

(51) Int. Cl. G06K 9/36

(52) U.S. Cl. 382/236; 375/240.16

(57) ABSTRACT

To code the current frame of a moving picture, a weighting coefficient and the mean pixel values in the current frame and a reference frame are obtained. The weighting coefficient is used to modify the mean pixel value in the reference frame, and an offset value is calculated from the resulting modified mean pixel value and the mean pixel value in the current frame. Reference image blocks are then selected from the reference frame, and a predicted image block is generated by applying the weighting coefficient and the offset value to each selected reference image block. Because of the modification of the mean pixel value of the reference frame, pixel values in the predicted image blocks are distributed around the mean pixel value in the current frame, which leads to efficient coding.

### BACKGROUND OF THE INVENTION

1. Field of the Invention

The present invention relates to the coding of moving pictures, more particularly to the generation of predicted images for use in inter-frame predictive coding.

2. Description of the Related Art

Inter-frame predictive coding is a known technique in which the values of the pixel elements (pixels) in the current frame are predicted from the pixel values in a reference frame and only the differences between the predicted and actual pixel values are coded. If the prediction is good, many of the differences will be zero or close to zero, enabling the coded data to be greatly compressed. One example of inter-frame predictive coding is given by the advanced video coding standard (MPEG-4 AVC) of the Moving Picture Experts Group, also known as the H.264 standard of the Telecommunication Standardization Sector of the International Telecommunication Union (ITU-T), and formerly as standard 14496-10 of the International Organization for Standardization and International Electrotechnical Commission (ISO/IEC).

Since reducing the predictive error improves the compression ratio, methods of improving the accuracy of the image predictions are of considerable value. One known method, disclosed by Koto et al. in Japanese Patent Application Publication (JP) No. 2004-7379, improves image prediction accuracy by adjusting the predicted pixel values according to differences in brightness statistics between the current and reference frames. Briefly, a weighting coefficient related to the amount of pixel variation in the current and reference frames and an offset value equal to the difference between the mean pixel values in the current and reference frames are obtained. The predicted pixel values are generated by multiplying pixel values in the reference image block by the weighting coefficient and adding the offset value.

A problem with this method is that despite the adding of the offset value, the predicted pixel values may be distributed around a mean value that differs significantly from the mean pixel value in the current frame. A more detailed description of this problem will be given in the detailed description of the invention.

### SUMMARY OF THE INVENTION

A general object of the present invention is to reduce predictive error in inter-frame predictive coding of moving pictures.

A more specific object is to approximate the current frame of a moving picture by generating a predicted frame such that the mean pixel value in the predicted frame closely matches the mean value pixel value in the current frame.

The invention provides a novel method of generating a predicted image block from a reference image block, where the reference image block is a block of pixels in a reference frame and the predicted image block corresponds to an image block in a current frame. The method includes:

calculating a weighting coefficient;

calculating the mean pixel value in the current frame;

calculating the mean pixel value in the reference frame;

calculating an offset value from the weighting coefficient, the mean pixel value in the current frame, and the mean pixel value in the reference frame; and

generating the predicted image block from the reference image block, the weighting coefficient, and the offset value.

Pixel values in the predicted image block may be calculated by multiplying corresponding pixel values in the reference image block by the weighting coefficient and adding the offset value to the resulting products.

The offset value may be calculated by multiplying the mean pixel value in the reference frame by the weighting coefficient and subtracting the resulting product from the mean pixel value in the current frame.

As a result, the mean pixel value in the predicted image frame becomes substantially equal to the mean pixel value in the current frame, so the predictive error is reduced and coding efficiency is improved.

The invention also provides an image coding method using the invented method to generate predicted image blocks.

The invention further provides apparatus for generating image blocks and coding images by the invented methods, and machine-readable media storing programs for implementing the invented methods.

### BRIEF DESCRIPTION OF THE DRAWINGS

In the attached drawings:

FIG. 1 is a graph illustrating mean pixel values during a fade-in;

FIG. 2 is a graph illustrating the relation between mean pixel values in the reference image and the current image during the fade-in;

FIG. 3 is a graph also illustrating the relation between mean pixel values in the predicted image and the reference image when conventional prediction is applied;

FIG. 4 is a block diagram of a moving picture coding apparatus embodying the invention;

FIG. 5 is a block diagram illustrating the functional structure of the weight calculator in FIG. 4;

FIG. 6 is a block diagram illustrating the functional structure of the offset calculator in FIG. 4; and

FIG. 7 is a flowchart illustrating the operation of the predicted image block generator.

### DETAILED DESCRIPTION OF THE INVENTION

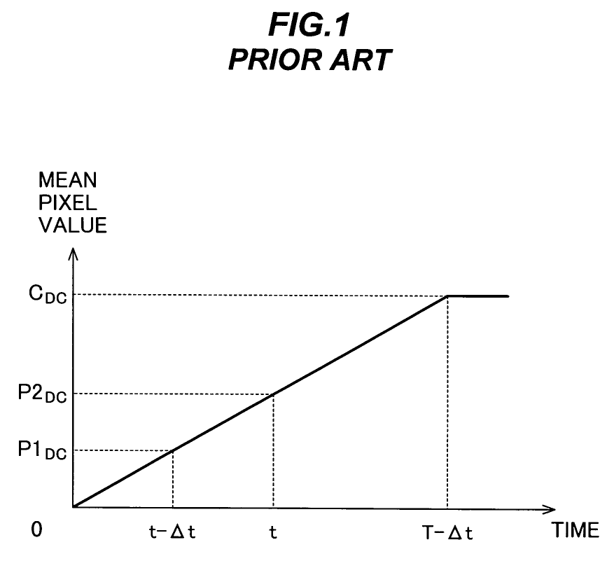

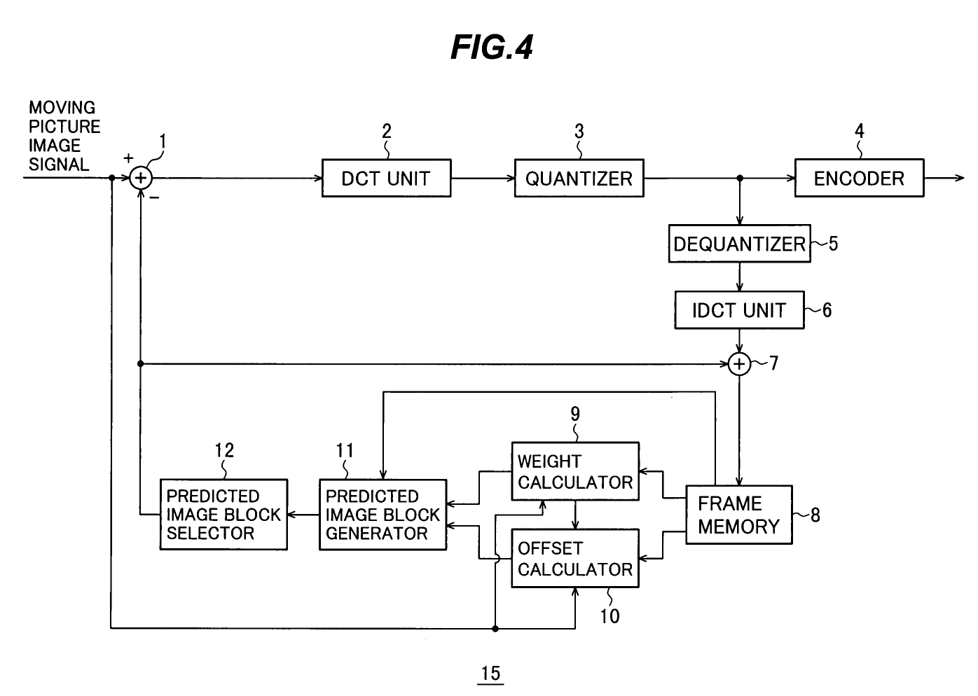

A more detailed description of the image prediction method disclosed in JP 2004-7379 and the problem of this method will now be given with reference to FIGS. 1 to 3. An exemplary embodiment of the invention will then be described with reference to FIGS. 4 to 7.

In general, the first step in predicting the pixel values in an image block in the current frame is to extract a similar reference image block from the reference frame. The reference image block may be in a different position from the current image block, the positional relationship being described by a motion vector. A plurality of reference image blocks may be extracted from the same reference frame, or from different reference frames.

For each reference frame, a weighting coefficient W and offset value D are calculated in relation to the current frame. In JP 2004-7379 (paragraphs 0156-0171), the weighting coefficient W and offset value D are calculated as follows.

First, the mean value or direct-current (DC) component DCcur of the entire current frame, or of a slice of the frame including the block to be coded, is calculated by equation (1) below.

$$DCcur = \frac{{\sum }_{x , y} F ( x , y )}{N} \qquad ( 1 )$$

F(x, y) represents the value of the pixel at the position with coordinates (x, y) in frame F, and N is the number of pixels in the frame or slice.

Next, the magnitude of the space-varying or alternating-current (AC) component ACcur of the frame to be coded is calculated as the average absolute difference from the mean by the following equation (2).

$$AC cur = \frac{{\sum }_{x , y} \vert F ( x , y ) - DC cur \vert}{N} \qquad ( 2 )$$

An alternative method is to calculate the AC component ACcur as a standard deviation statistic, given by the following equation (3).

$$AC cur = \sqrt{\frac{{\sum }_{x , y} {( F ( x , y ) - DC cur )}^{2}}{N}} \qquad ( 3 )$$

The case in which the frame to be coded is paired with a plurality of reference frames will be considered below.

Using the letter i to indicate index numbers of the reference frames, the AC and DC components ACref(i) and DCref(i) of each reference frame or slice are calculated as above, and the weighting coefficient W(i) and offset value D(i) of each frame or slice are calculated from the following equations (4, 5).

W(i)=ACcur/ACref(i) (4)

D(i)=DCcur—DCref(i) (5)

A pixel value predᵢ in the predicted image block derived from the ith reference frame is given by the weighting coefficient W(i), the offset value D(i), and value ref(i) of the corresponding pixel in the ith reference frame as in equation (6).

predᵢ=W(i)×ref(i)+D(i) (6)

Finally, the differences between the predicted pixel values and the pixel values in the current block are coded and these coded values are output together with the coded values of the weighting coefficient W and offset value D.

The relation in equation (6) also holds if predᵢ is taken to be the mean pixel value in the current frame or slice, and ref(i) is taken to be the mean pixel value in the ith reference frame or slice.

Consider now a still-picture fade-in of duration T in which the frame at time t−Δt is used as a reference frame for coding the frame at time t. The pixel values S(x, y, t) in the frame at time t (the current frame) are given by the following equations (7, 8), where C(x, y) represents the final still image displayed from time T−Δt to time T.

$$\begin{matrix}S ( x , y , t ) = \frac{( t + Δ t )}{T} \times C ( x , y ) ( 0 < t < T - Δ t ) & ( 7 ) \\ S ( x , y , t ) = C ( x , y ) ( t \geq T - Δ t ) & ( 8 )\end{matrix}$$

The quantity Δt represents the length of the interval from the reference frame to the current frame. The fade-in may also be regarded as starting from a black screen at time−Δt and terminating at time T−Δt. While the fade-in is in progress (t<T−Δt), the AC and DC components of the current frame and reference frame have the values given by the equations (9-12) below, in which C_{DC} is the mean pixel value or DC component of the still picture.

$$\begin{matrix} DC cur = \frac{( t + Δ t )}{T} \times {C}_{DC} & ( 9 ) \\ DC ref = \frac{t}{T} {C}_{DC} & ( 10 ) \\ where , {C}_{DC} = \frac{{\sum }_{x , y} C ( , y )}{N} & \\ AC cur = \sqrt{\frac{{\sum }_{x , y} {\{ S ( x , y , t ) - DC cur \}}^{2}}{N}} = \frac{t + Δ t}{T} \times \sqrt{\frac{{\sum }_{x , y} {\{ C ( x , y ) - {C}_{DC} \}}^{2}}{N}} & ( 11 ) \\ AC ref = \sqrt{\frac{{\sum }_{x , y} {\{ S ( x , y , t - Δ t ) - DC ref \}}^{2}}{N}} = \frac{t}{T} \times \sqrt{\frac{{\sum }_{x , y} {\{ C ( x , y ) - {C}_{DC} \}}^{2}}{N}} & ( 12 )\end{matrix}$$

The weighting coefficient W and offset value D can be calculated from these equations as follows (13, 14):

$$\begin{matrix}W = \frac{AC cur}{AC ref} = 1 + \frac{Δ t}{t} & ( 13 ) \\ D = DC cur - DC ref = \frac{Δ t}{T} {C}_{DC} & ( 14 )\end{matrix}$$

If the value of Δt is sufficiently small in relation to T, the weighting coefficient W and offset value D will have substantially the same values as above even if the AC components are calculated by use of equation (2) instead of equation (3). The value of Δt may also be negative.

The pixel values pred(x, y, t) predicted from the reference frame shown at time t are given by the following equation (15), in which ref(x, y, t) is a pixel value in the reference frame at time t−Δt.

$$pred ( x , y , t ) = ( 1 + \frac{Δ t}{T} ) \times ref ( x , y , y ) + \frac{Δ t}{T} \times {C}_{DC} \qquad ( 15 )$$

The mean pixel value or DC component P1_{DC} of the reference frame and the mean pixel value or DC component P2_{DC} of the current frame are related to the DC component C_{DC} of the still picture as in the following equations (16, 17).

$$\begin{matrix}P {2}_{DC} = \frac{( t + Δ t )}{T} \times {C}_{DC} & ( 16 ) \\ P {1}_{DC} = \frac{t}{T} \times {C}_{DC} & ( 17 )\end{matrix}$$

These DC components P1_{DC} and P1_{DC} are accordingly related by the following equation (18).

$$P {2}_{DC} = P {1}_{DC} + \frac{Δ t}{T} \times {C}_{DC} \qquad ( 18 )$$

The fade-in process can be illustrated as shown in FIG. 1, in which time is indicated on the horizontal axis and the mean pixel values of the still picture (C_{DC}), the current frame (P2_{DC}), and the reference frame (P1_{DC}) are indicated on the vertical axis.

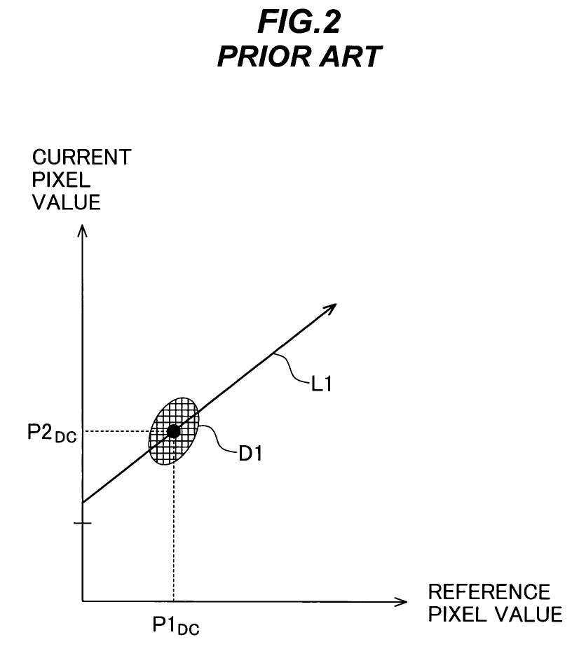

The relationship between the DC components P1_{DC} and P2_{DC} of the reference frame and the current frame is illustrated by the black dot in FIG. 2. The surrounding ellipse D1 indicates that the individual pixel values in each frame are distributed around the mean value. During the fade-in, this distribution moves upward and to the left along line L1.

The mean pixel value or DC component of the predicted image is defined as in equation (19). Substitution of equation (15) into equation (19) yields equation (20).

$$\begin{matrix}{pred}_{DC} = {\sum }_{x , y} \{ \frac{pred ( x , y , t )}{N} \} & ( 19 ) \\ {pred}_{DC} = ( 1 + \frac{Δ t}{t} ) \times {\sum }_{x , y} \frac{ref ( x , y , t )}{N} + \frac{Δ t}{T} \times {C}_{DC} & ( 20 )\end{matrix}$$

Substitution of the value in equation (17) for the term Σref(x, y, t)/N in equation (20) yields equation (21), which can be simplified as shown in equation (22).

$$\begin{matrix}{pred}_{DC} = ( 1 + \frac{Δ t}{t} ) \times ( \frac{t}{T} \times {C}_{DC} ) + \frac{Δ t}{T} \times {C}_{DC} & ( 21 ) \\ {pred}_{DC} = \frac{t + Δ t}{T} \times {C}_{DC} + \frac{Δ t}{T} \times {C}_{DC} & ( 22 )\end{matrix}$$

It follows that:

$${pred}_{DC} = DC cur + \frac{Δ t}{T} \times {C}_{DC} \qquad ( 23 )$$

Since the DC component DCcur of the current frame is the same as the quantity P2_{DC} defined above,

$${pred}_{DC} = P {2}_{DC} + \frac{Δ t}{T} \times {C}_{DC} \qquad ( 24 )$$

That is, the mean value of the pixels in the predicted image blocks exceeds the mean pixel value in the current frame by the quantity (Δt/T)×C_{DC}.

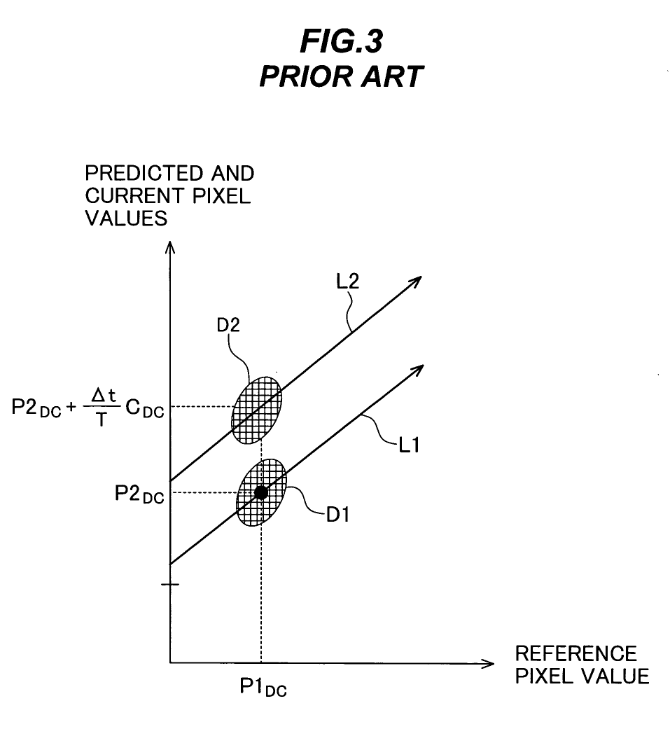

Referring to FIG. 3, this means that the distribution D2 of pixel values in the predicted image blocks is biased away from the actual distribution D1 of pixel values in the current image; the predicted pixel values tend to exceed the actual values. This difference is maintained as the distributions in FIG. 3 move upward and to the right along the lines L1 and L2 during the fade-in.

Accordingly, even during an extremely simple process such as a fade-in or fade-out, with the conventional prediction scheme, the differences between the pixel values in the current frame and the corresponding pixel values in the predicted frame tend to cluster not around zero but around the quantity (Δt/t)×C_{DC}, resulting in poor coding efficiency.

Referring now to FIG. 4, an exemplary moving picture coding apparatus 15 embodying the present invention comprises at least a subtractor 1, a discrete cosine transform (DCT) unit 2, a quantizer 3, an encoder 4, a dequantizer 5, an inverse discrete cosine transform (IDCT) unit 6, an adder 7, a frame memory 8, a weight calculator 9, an offset calculator 10, a predicted image block generator 11, and a predicted image block selector 12. These processing elements may be implemented by specialized hardware logic, or by a central processing unit (CPU) such as a microprocessor executing programs stored in memory circuits or other suitable media. The weight calculator 9, offset calculator 10, and predicted image block generator 11 constitute an image predictor.

The moving picture coding apparatus 15 receives a moving picture image signal divided into frames, divides each image frame into predetermined blocks of pixels, and codes each image block separately.

The subtractor 1 takes differences between the pixel values in an image block in the current frame and corresponding predicted pixel values supplied from the predicted image block selector 12, and sends a predictive error signal indicating the differences to the DCT unit 2.

The DCT unit 2 executes a discrete cosine transform on each received block of difference values, and outputs resulting DCT coefficient data to the quantizer 3.

The quantizer 3 quantizes the DCT coefficient data, and outputs the resulting quantized DCT coefficient data to the encoder 4 and dequantizer 5.

The encoder 4 codes the quantized DCT coefficient data and outputs the coded data to, for example, a data storage device (not shown), or to a data transmission apparatus for transmission to a remote apparatus (not shown) where the data will be decoded.

The dequantizer 5 dequantizes the quantized DCT coefficient data and outputs the resulting DCT coefficient data to the IDCT unit 6.

The IDCT unit 6 performs an inverse discrete cosine transform on the DCT coefficient data received from the dequantizer 5 to obtain a reproduced predictive error signal, which is supplied to the adder 7.

The adder 7 adds predicted pixel values output by the predicted image block selector 12 to the reproduced predictive error signal received from the IDCT unit 6 to generated a local reproduced image signal, and stores the local reproduced image signal in the frame memory 8.

The frame memory 8 stores the local reproduced image signal for at least one entire frame and outputs the stored image data as a reference image signal to the weight calculator 9, offset calculator 10, and predicted image block generator 11. The reference image signal is output to the predicted image block generator 11 in a series of blocks which may be related by motion vectors to the image blocks in the current frame. The predicted image block generator 11 may output a single reference image block for each image block in the current frame, or may output a plurality of reference image blocks with different motion vectors.

The weight calculator 9 reads the reference image data stored in the frame memory 8 and calculates the AC component ACref of the reference frame that will be used to code the current frame. The weight calculator 9 also receives the input image signal and calculates the AC component ACcur of the current frame by, for example, the conventional absolute-difference equation (2) or standard deviation equation (3). The same method should be used for calculating the AC components of both the current frame and the reference frame. The weight calculator 9 then calculates a weighting coefficient W from the values of these AC components and supplies the weighting coefficient W to the offset calculator 10 and predicted image block generator 11.

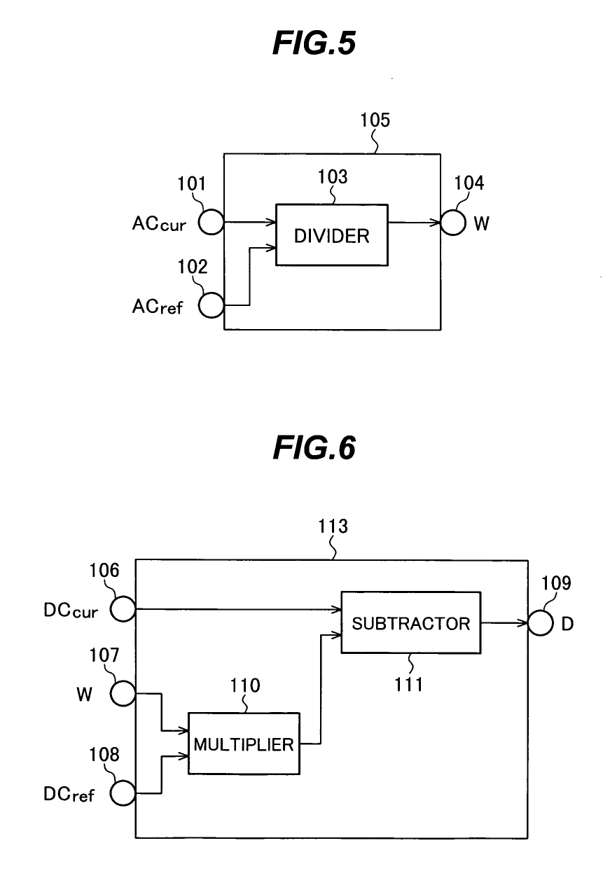

FIG. 5 shows the functional structure of the weight calculation unit 105 which calculates the weighting coefficient W in the weight calculator 9. The weight calculation unit 105 has an input terminal 101 that receives the AC component ACcur of the current frame, another input terminal 102 that receives the AC component ACref of the reference frame, a divider 103 that divides the AC component ACcur of the current frame by the AC component ACref of the reference frame, and an output terminal 104 from which the resulting quotient is output as the weighting coefficient W. The weighting coefficient W is accordingly calculated by the following equation (25), as in the prior art.

$$W = \frac{AC cur}{AC ref} \qquad ( 25 )$$

The offset calculator 10 reads the reference image data stored in the frame memory 8 and calculates the DC component DCref of the reference frame, receives the input image signal and calculates the DC component DCcur of the current frame, and receives the weighting coefficient W calculated by the weight calculator 9. From these values, the offset calculator 10 calculates an offset value D and supplies it to the predicted image block generator 11.

FIG. 6 shows the functional structure of the offset calculation unit 113 which calculates the offset value D in the offset calculator 10. The offset calculation unit 113 has an input terminal 106 that receives the DC component DCcur of the current frame, another input terminal 107 that receives the weighting coefficient W, yet another input terminal 108 that receives the DC component DCref of the reference frame, a multiplier 110 that multiplies the DC component DCref of the reference frame by the weighting coefficient W, a subtractor 111 that subtracts the resulting product from the DC component DCcur of the current frame, and an output terminal 109 from which the resulting difference is output as the offset value D. The offset value D is accordingly calculated by the following novel equation (26).

$$D = ( DC cur - \frac{AC cur}{AC ref} \times DC ref ) \qquad ( 26 )$$

Although the weight calculator 9 and offset calculator 10 are shown for clarity as separate units, since the DC component value is used in the calculation of the AC component value, the weight calculator 9 and offset calculator 10 may share the same DC component calculation unit (not shown). Alternatively, if the moving picture coding apparatus 15 is used in apparatus that calculates AC and DC component values for other purposes, these values may be stored in suitable memory areas and simply read by the weight-calculator 9 and offset calculator 10. In particular, the AC and DC components of the reference frame may be stored in the frame memory 8 together with the reference pixel data.

The weight calculator 9 may also obtain a weighting coefficient W that has been calculated from the current and reference frames for some other image-processing purpose by apparatus not shown in the drawings, and use that weighting coefficient instead of calculating the weighting coefficient itself.

The weight calculator 9 may calculate or obtain a plurality of weighting coefficients calculated by different methods or for different reference frames, and the offset calculator 10 may calculate a corresponding plurality of offset values by the above equation (26). In this case the predicted image block generator 11 receives a plurality of pairs of weighting coefficients and corresponding offset values from the weight calculator 9 and offset calculator 10.

For each image block in the input image signal and pair of values (weighting coefficient and offset value) received from the weight calculator 9 and offset calculator 10, the predicted image block generator 11 reads one or more reference image blocks from the frame memory 8, and calculates a predicted image block of pixel values from each reference image block by the following equation (27), where pred indicates a predicted pixel value and ref indicates the corresponding reference pixel value.

pred=W×ref+D (27)

If the above equations (25, 26) for the weighting coefficient W and offset value D are substituted into this equation (27), the equation for the predicted pixel values can be obtained in the following expanded form (28).

$$pred = ( \frac{AC cur}{AC ref} ) \times ref + ( DC cur - \frac{AC cur}{AC ref} \times DC ref ) \qquad ( 28 )$$

If the predicted image block generator 11 generates more than one predicted image block per input image block, the predicted image block selector 12 selects one of the predicted image blocks for each input image block according to a predetermined statistical criterion. For example, the predicted image block selector 12 may select the predicted image block with the most zero values, or the most values with absolute magnitudes less than a predetermined value. If there is only one predicted image block per current image block, the predicted image block selector 12 selects the one predicted image block.

The predicted image block selected by the predicted image block selector 12 is coded by the DCT unit 2, quantizer 3, and encoder 4 as described above. The weighting coefficient, offset value, and motion vector of the selected predicted image block are also coded and output together with the coded data. If the same weighting coefficient and offset value are used for all image blocks in the current frame, then these two values need be coded only once per frame.

If the value of a reference pixel is equal to the DC component DCref of the reference frame, the above equation (28) reduces to the following equation (29), showing that the value of the corresponding predicted pixel is equal to the DC component DCcur of the current frame.

pred=DCcur (29)

Since the pixel values in the reference frame are distributed around the mean pixel value in the reference frame, the predicted pixel values will be similarly distributed around the value in equation (29). That is, the predicted pixel values will be distributed around the actual mean pixel value or DC component of the current frame, as in distribution D1 in FIG. 3, and not around some other value as in distribution D2.

Due to motion compensation and to the selections made by the predicted image block selector 12, the mean value of all the pixels in the predicted image blocks selected by the predicted image block selector 12 to use in coding the current frame may not be exactly equal to the mean pixel value in the current frame, but it will usually be close to the mean pixel value in the current frame, and there will be no inherent bias of the type produced by the prior art during a fade-in or fade-out.

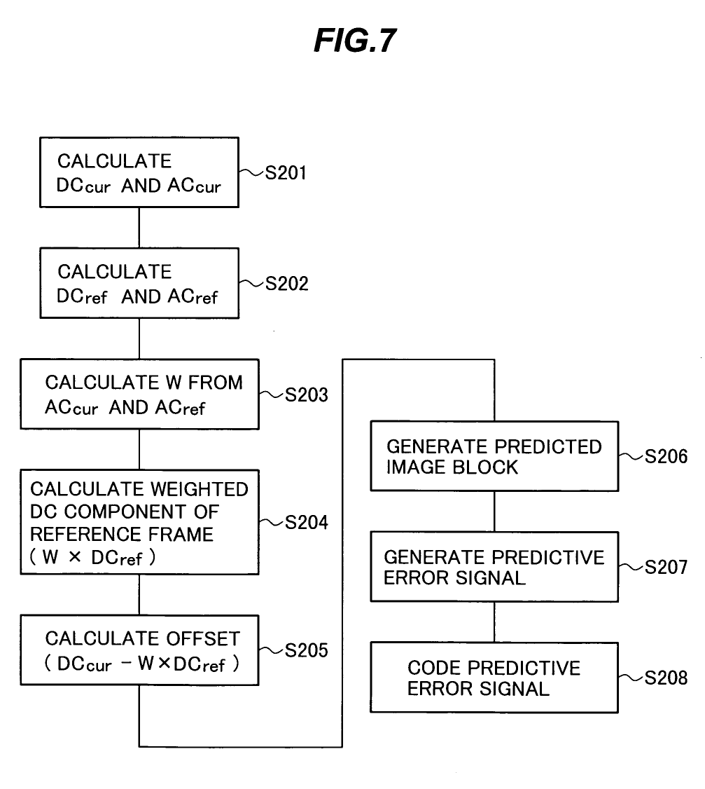

The operation of the moving picture coding apparatus 15 in the present embodiment is summarized by the flowchart in FIG. 7. For simplicity, it is assumed that the weight calculator 9 generates only one weighting coefficient per frame and the predicted image block generator 11 reads only one reference image block for each input image block, so no selection operation by the predicted image block selector 12 is required.

First, as the image signal is input, the AC component ACcur and DC component DCcur of the current frame are calculated (step S201).

In addition, the AC component ACref and DC component DCref of the reference frame are calculated (step S202).

Next, the weight calculator 9 calculates the weighting coefficient W from the AC component values ACcur and ACref of the current frame and reference frame (step 203).

Next, the DC component DCref of the reference frame is multiplied by the weighting coefficient W to calculate a weighted DC component (W×DCref) for the reference frame (step S204).

The weighted DC component (W×DCref) of the reference frame is then subtracted from the DC component DCcur of the current frame to generate an offset value D (step S205).

The weighting coefficient W and offset value D are now used to generate the predicted image block from the reference image block. Each reference pixel value is multiplied by the weighting coefficient, and the offset value is added to the result to obtain the predicted pixel value (step S206).

The predicted pixel values are then subtracted from the pixel values in the current frame to obtain a predictive error signal (step S207), and the predictive error signal is coded (step S208).

If two or more predicted image blocks are generated for a single input image block, one of the predicted image blocks would be selected after step S206, and steps S207 would be carried out using the selected block.

Steps S206 to S208 involve well-known procedures such as motion vector generation, which will not be described in detail.

It will be appreciated that the input image signal is buffered while the predictive error signal is being generated in steps S201 to S207, and that further buffering takes place in the coding process, but these buffering processes are also well known and will not be described in detail. The relevant buffer memories have been omitted from FIG. 4 for simplicity.

The effect of the above embodiment is that, because the DC component of the reference frame is modified by the weighting coefficient before being subtracted from the DC component of the current frame to generate the offset value, the pixel values in the predicted image blocks are distributed around substantially the same mean value as the pixel values in the current frame, the mean predictive error is reduced accordingly, and coding efficiency is improved.

This effect is not limited to the moving picture coding apparatus in the preceding embodiment. A similar effect is obtained if the present invention is practiced in any apparatus that generates predicted image blocks from reference image blocks by multiplying the reference pixel values by a weighting coefficient and adding an offset value.

The method of calculating the AC and DC components is not limited to the equations (1 to 3) given above. The invention may be practiced with AC and DC component values calculated by any known method.

The weighting coefficient W need not be calculated as a ratio of AC components. Other weighting methods may be used.

The frames referred to herein may be full-picture frames, or fields or slices of such frames.

Those skilled in the art will recognize that further variations are possible within the scope of the invention, which is defined in the appended claims.

What is claimed is:

1. An image predictor for generating a predicted image block from a reference image block, the reference image block being a block of pixels in a reference frame in a moving picture, the predicted image block approximating an image block in a current frame in the moving picture, the apparatus comprising:
a weight calculator for obtaining a weighting coefficient;
an offset calculator for obtaining a mean pixel value in the current frame and a mean pixel value in the reference frame and calculating an offset value from the weighting coefficient, the mean pixel value in the current frame, and the mean pixel value in the reference frame; and
a predicted image block generator for generating the predicted image block from the reference image block, the weighting coefficient, and the offset value.

2. The image predictor of claim 1, wherein the predicted image block generator calculates pixel values in the predicted image block by multiplying corresponding pixel values in the reference image block by the weighting coefficient and adding the offset value.

3. The image predictor of claim 1, wherein the offset calculator uses the weighting coefficient to modify the mean pixel value of the reference frame, thereby obtaining a modified mean pixel value, and calculates the offset value from the mean pixel value in the current frame and the modified mean pixel value.

4. The image predictor of claim 1, wherein the offset calculator multiplies the mean pixel value of the reference frame by the weighting coefficient to obtain a modified mean pixel value and subtracts the modified mean pixel value from the mean pixel value in the current frame to calculate the offset value.

5. The image predictor of claim 1, wherein the weight calculator obtains the weighting coefficient by calculating a first statistic of pixel values in the current frame, calculating a second statistic of pixel values in the reference frame, and dividing the first statistic by the second statistic.

6. The image predictor of claim 1, wherein the weight calculator obtains a plurality of weighting coefficients, the offset calculator calculates a corresponding plurality of offset values from respective ones of the plurality of weighting coefficients, the mean pixel value in the current image, and the mean pixel value in the reference image, and the predicted image block generator generates a corresponding plurality of predicted image blocks from the reference image, the weighting coefficients, and the offset values, the image predictor further comprising:
a predicted image block selector for selecting and outputting one of the plurality of predicted image blocks.

7. A moving picture coder for coding a current frame in a moving picture with reference to a reference frame in the moving picture, comprising:
the image predictor of claim 1 for obtaining a weighting coefficient, calculating an offset value, and generating predicted image blocks from reference image blocks in the reference frame; and
apparatus for coding the weighting coefficient and the offset value, dividing the current frame into image blocks, selecting a reference image block in the reference frame for each image block in the current frame, and coding differences between pixel values in the current frame and pixel values in the predicted image block generated by the image predictor from each selected reference image block.

8. A method of generating a predicted image block from a reference image block, the reference image block being a block of pixels in a reference frame in a moving picture, the predicted image block approximating an image block in a current frame in the moving picture, the method comprising:
obtaining a weighting coefficient, a mean pixel value in the current frame, and a mean pixel value in the reference frame;
calculating an offset value from the weighting coefficient, the mean pixel value in the current frame, and the mean pixel value in the reference frame; and
generating the predicted image block from the reference image block, the weighting coefficient, and the offset value.

9. The method of claim 8, wherein generating the predicted image block further comprises calculating pixel values in the predicted image block by multiplying corresponding pixel values in the reference image block by the weighting coefficient and adding the offset value.

10. The method of claim 8, wherein calculating the offset value further comprises:
using the weighting coefficient to modify the mean pixel value of the reference frame, thereby obtaining a modified mean pixel value; and
calculating the offset value from the mean pixel value in the current frame and the modified mean pixel value.

11. The method of claim 8, wherein calculating the offset value further comprises:
multiplying the mean pixel value of the reference frame by the weighting coefficient to obtain a modified mean pixel value; and
subtracting the modified mean pixel value from the mean pixel value in the current frame to calculate the offset value.

12. The method of claim 8, wherein obtaining the weighting coefficient further comprises:
calculating a first statistic of pixel values in the current frame;
calculating a second statistic of pixel values in the reference frame; and
dividing the first statistic by the second statistic.

13. A machine-readable tangible medium storing instructions executable by a computing device to generate a predicted image block from a reference image block by the method of claim 8, the reference image block being a block of pixels in a reference frame in a moving picture, the predicted image block approximating an image block in a current frame in the moving picture.

14. A method of coding a current frame in a moving picture with reference to a reference frame in the moving picture, comprising:
obtaining a weighting coefficient, a mean pixel value in the current frame, and a mean pixel value in the reference frame;
calculating an offset value from the weighting coefficient, the mean pixel value in the current frame, and the mean pixel value in the reference frame;
coding the weighting coefficient and the offset value;
dividing the current frame into blocks;
selecting a reference image block in the reference frame for each block in the current frame;
generating a predicted image block for each selected reference image block from the selected reference image block, the weighting coefficient, and the offset value; and
coding differences between pixel values in the current frame and pixel values in the predicted image block generated from each selected reference image block.

15. The method of claim 14, wherein generating the predicted image block further comprises calculating pixel values in the predicted image block by multiplying corresponding pixel values in the reference image block by the weighting coefficient and adding the offset value.

16. The method of claim 14, wherein calculating the offset value further comprises:
using the weighting coefficient to modify the mean pixel value of the reference frame, thereby obtaining a modified mean pixel value; and
calculating the offset value from the mean pixel value in the current frame and the modified mean pixel value.

17. The method of claim 14, wherein calculating the offset value further comprises:
multiplying the mean pixel value of the reference frame by the weighting coefficient to obtain a modified mean pixel value; and
subtracting the modified mean pixel value from the mean pixel value in the current frame to calculate the offset value.

18. The method of claim 14, wherein obtaining the weighting coefficient further comprises:
calculating a first statistic of pixel values in the current frame;
calculating a second statistic of pixel values in the reference frame; and
dividing the first statistic by the second statistic.

19. A machine-readable tangible medium storing instructions executable by a computing device to code a current frame in a moving picture with reference to a reference frame in the moving picture by the method of claim 14.
